(19) United States
(12) Patent Application Publication
(10) Pub. No.: US 2009/0214827 A1
(43) Pub. Date: Aug. 27, 2009

(54) SPECIAL VISUAL EFFECT THERMOPLASTIC COMPOSITIONS, ARTICLES MADE THEREFROM, AND METHOD

(76) Inventor: Douglas Howie, JR., Parkersburg, WV (US)

Correspondence Address: SABIC- ESR;SABIC Innovative Plastics - IP Legal, ONE PLASTICS AVENUE, PITTSFIELD, MA, 01201-3697, US

(21) Appl. No.: 12/201,028

(22) Filed: Aug. 29, 2008

Related U.S. Application Data
(63) Continuation-in-part of application No. 10/837,865, filed on May 3, 2004, now abandoned.

(51) Int. Cl. B32B 5/16; C08K 7/18; C08K 7/16

(52) U.S. Cl. 428/143; 523/223

(57) ABSTRACT

The present invention relates to a composition comprising rubber modified thermoplastic resins which show special visual effects such as a metallic sparkle effect and/or other special visual effect from the surface of thermoplastic articles comprising the composition. In a particular embodiment the present invention relates to a composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and (ii) a plurality of microsphere beads having a diameter in a range of about 1 to about 1300 microns and having an index of refraction ranging from about 1.4 to about 2.5, wherein the microsphere beads are present in the composition in an amount in a range of between about 1 phr and about 14 phr, and wherein the microsphere beads provide a special visual effect on the surface of an article made from the composition. In other embodiments the present invention relates to articles made from the composition and to methods for providing a special visual effect and also for enhancing the image texture value of the surface of the article.

### CROSS-REFERENCE TO RELATED APPLICATIONS

This application is a continuation-in-part of application Ser. No. 10/837,865, filed May 3, 2004, which is incorporated herein by reference.

### BACKGROUND

The present invention relates to compositions comprising a rubber modified thermoplastic resin and a plurality of microsphere beads. The compositions are suitable for fabrication into articles with special visual effects. In particular the compositions may be fabricated into articles showing a metallic sparkle effect or other special visual effect.

Articles with special visual effect surface properties such as a metallic sparkle effect or other special visual effect are continually in demand for commercial applications. A metallic sparkle effect may often be introduced into a thermoplastic article by using metallic or mineral flakes or pigment. However, the magnitude of the sparkle effect depends upon such factors as the surrounding thermoplastic matrix and may require excessive loading of metallic sparkle elements to achieve a suitable effect.

Commercial products exhibiting special visual effects are well known. Special visual effects may be provided by micron-scaled optical elements, such as microsphere beads, or “cube-corner” prisms, which act as reflectors to direct incident light back to the light source. Reflectivity may be further enhanced by employing optical elements partially coated with a metallic or ceramic film. Typically, optical elements are applied to the surface of a pre-formed part, optimizing the reflectivity. For example, reflective properties in fabricated articles have been provided by a monolayer of transparent microsphere beads partially embedded in, and partially protruding out of, a support material as described, for example in U.S. Pat. No. 3,190,178. The monolayer of transparent microsphere beads is embedded in the support material by bringing the support material into contact with the beads for example using a drum covered with a sheet of support material on kraft paper. In other common examples reflective properties in fabricated articles have been provided by applying a reflective coating onto the article as described, for example, in U.S. Pat. No. 5,650,213; or by applying a reflective film with light refracting elements on the top surface thereof as described, for example, in U.S. Pat. No. 5,880,885. One disadvantage of these processes is that it is often difficult to prepare articles with irregularly shaped surfaces. A problem to be solved is to prepare a thermoplastic article with special visual effect surface properties without the need for providing a monolayer of microsphere beads on the surface thereof, or applying a reflective coating or film. In other fabricated articles special visual effect properties have been provided by employing reflective elements either laminated between two plastic sheets as described for example in U.S. Pat. No. 4,505,967; or coated with a curable thermoset resin as described for example in U.S. Pat. No. 4,025,159. The need for a multistep lamination process or for a thermoset resin requiring a curing process limits the physical properties and processing options for the final article. A further problem to be solved is to devise a process to fabricate a thermoplastic article with special visual effect surface properties using common thermoplastic processing techniques.

### BRIEF DESCRIPTION

The present inventors have discovered compositions with special visual effect surface properties which may be made using common thermoplastic processing techniques. In addition, the compositions and method do not require providing an excessive amount of metallic sparkle elements, or providing a monolayer of reflective elements or a reflective coating to an article's surface. In a particular embodiment the present invention relates to a composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and (ii) a plurality of microsphere beads having a diameter in a range of about 1 to about 1300 microns and having an index of refraction ranging from about 1.4 to about 2.5, wherein the microsphere beads are present in the composition in an amount in a range of between about 1 phr and about 14 phr, and wherein the microsphere beads provide a special visual effect on the surface of an article made from the composition.

In another particular embodiment the present invention relates to a composition comprising: (i) a rubber modified thermoplastic resin comprising about 35 to about 70 wt. % based on the total weight of the resin of an elastomeric phase comprising structural units derived from either butyl acrylate or butadiene, wherein the elastomeric phase is dispersed in a rigid thermoplastic phase, wherein at least a portion of the rigid thermoplastic phase is grafted to the elastomeric phase, and wherein the rigid thermoplastic phase comprises structural units derived from a monomer mixture comprising styrene and acrylonitrile or, from a monomer mixture comprising styrene, acrylonitrile and methyl methacrylate, wherein styrene and acrylonitrile are employed in a wt./wt. ratio in a range of between about 1.5:1 and about 4:1, and the wt./wt. ratio of methyl methacrylate to the total of styrene and acrylonitrile is in a range of between about 3:1 and about 1:5; (ii) a plurality of microsphere beads present in an amount in a range of between about 1 phr and about 14 phr and having a diameter in a range of about 1 to about 1300 microns and having an index of refraction ranging from about 1.4 to about 2.5, wherein the microsphere beads provide a special visual effect on the surface of an article made from the composition; and (iii) an additive selected from the group consisting of mineral flakes, metallic flakes, colorants, dyes, pigments, lubricants, stabilizers, fillers and mixtures thereof.

In still another particular embodiment the present invention relates to method for providing a special visual effect to the surface of a thermoplastic article, wherein the article comprises a composition comprising: a rubber modified thermoplastic resin comprising a discontinuous elastomeric phase dispersed in a rigid thermoplastic phase, wherein at least a portion of the rigid thermoplastic phase is grafted to the elastomeric phase; wherein the method comprises the steps of (i) adding to the composition a plurality of microsphere beads in an amount in a range of between about 1 phr and about 14 phr, said beads having a diameter in a range of about 1 to about 1300 microns and having an index of refraction ranging from about 1.4 to about 2.5 wherein the microsphere beads provide a special visual effect on the surface of the article; (ii) compounding the composition with intimate mixing; and (iii) forming the article therefrom, wherein only a portion of the plurality of microsphere beads is present at the surface of the article, and wherein the surface of said article exhibits an image texture value of at least 2.5.

In other embodiments the present invention relates to articles made from the composition and to a method to enhance the image texture of the surface of the article. Articles of the invention surprisingly exhibit special visual effect surface properties despite having only a portion of the plurality of microsphere beads present at the article's surface. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. As used herein the term “polycarbonate” refers to polycarbonates comprising structural units derived from a carbonate precursor and at least one dihydroxy-substituted aromatic hydrocarbon, and includes copolycarbonates. “Special visual effects” in the present context refer to a metallic sparkle effect or to retroreflective properties or to other differential reflective effects arising from individual surface elements in comparison to the background of the matrix comprising said elements, or to a combination of effects, when exhibited by the surface of articles formed from compositions of the invention.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions of the present invention comprise a rubber modified thermoplastic resin comprising a discontinuous elastomeric phase and a rigid thermoplastic phase wherein at least a portion of the rigid thermoplastic phase is grafted to the elastomeric phase. The discontinuous elastomeric phase comprises a rubber substrate to which at least a portion of the rigid thermoplastic phase is grafted. There is no particular limitation on the rubber substrate provided it is susceptible to grafting by at least a portion of a graftable monomer. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the T_{g} of a polymer is the T_{g} value of polymer as measured by differential scanning calorimetry (DSC; heating rate 20° C./minute, with the T_{g} value being determined at the inflection point).

In a one embodiment, the elastomeric phase comprises a polymer having structural units derived from one or more unsaturated monomers selected from conjugated diene monomers, non-conjugated diene monomers or (C₁-C₁₂) alkyl (meth)acrylate monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4, hexadiene, dichlorobutadiene, bromobutadiene and dibromobutadiene as well as mixtures of conjugated diene monomers. In a particular embodiment, the conjugated diene monomer is 1,3-butadiene. Suitable non-conjugated diene monomers include, e.g., ethylidene norbornene, dicyclopentadiene, hexadiene or phenyl norbornene.

In some embodiments the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “monoethylenically unsaturated” means having a single site of ethylenic unsaturation per molecule, and the terminology “(meth)acrylate monomers” refers collectively to acrylate monomers and methacrylate monomers. As used herein, the terminology “(Cₓ-C_{y})” as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also comprise a minor amount, for example up to about 5 wt. %, of structural units derived from at least one polyethylenically unsaturated monomer, for example those that are copolymerizable with a monomer used to prepare the rubber substrate. As used herein, the terminology “polyethylenically unsaturated” means having two or more sites of ethylenic unsaturation per molecule. A polyethylenically unsaturated monomer is often employed to provide cross-linking of the rubber particles and/or to provide “graftlinking” sites in the rubber substrate for subsequent reaction with grafting monomers. Suitable polyethylenic unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallylcyanurate, triallylisocyanurate, the acrylate of tricyclodecenylalcohol and mixtures comprising at least one of such monomers. In a particular embodiment the rubber substrate comprises structural units derived from triallylcyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 percent by weight (“wt. %”) of structural units derived from one or more monomers selected from (C₂-C₈)olefin monomers, (meth)acrylate monomers, vinyl aromatic monomers and monoethylenically unsaturated nitrile monomers. As used herein, the term “(C₂-C₈)olefin monomers” means a compound having from 2 to 8 carbon atoms per molecule and having a single site of ethylenic unsaturation per molecule. Suitable (C₂-C₈)olefin monomers include, but are not limited to, ethylene, propene, 1-butene, 1-pentene, heptene, and the like. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof; monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides and haloaryl substituted maleimides; maleic anhydride; vinyl methyl ether, vinyl esters, such as, for example, vinyl acetate and vinyl propionate. As used herein, the term “(meth)acrylamide” refers collectively to acrylamides and methacrylamides. Suitable vinyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, vinyl toluene, alpha-methyl vinyltoluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the rubber substrate comprises from 60 to 100 wt. % repeating units derived from one or more conjugated diene monomers and from 0 to 40 wt. % repeating units derived from one or more monomers selected from vinyl aromatic monomers and monoethylenically unsaturated nitrile monomers, such as, for example, a poly(butadiene), a styrene-butadiene copolymer, an acrylonitrile-butadiene copolymer or a styrene-butadiene-acrylonitrile copolymer. In another particular embodiment the rubber substrate comprises from 70 to 90 wt. % repeating units derived from one or more conjugated diene monomers and from 30 to 10 wt. % repeating units derived from one or more monomers selected from vinyl aromatic monomers. In another particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, more preferably from one or more monomers selected from ethyl acrylate, butyl acrylate and n-hexyl acrylate.

The rubber substrate may be present in the rubber modified thermoplastic resin portion of the compositions of the invention in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in compositions of the invention at a level of from about 5 wt. % to about 50 wt. %; at a level of from about 8 wt. % to about 40 wt. %; or at a level of from about 10 wt. % to about 30 wt. %, based on the weight of the rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad particle size distribution with particles ranging in size from about 50 nm to about 1000 nm. In other embodiments the mean particle size of the initial rubber substrate may be less than about 100 nm. In still other embodiments the mean particle size of the initial rubber substrate may be in a range of between about 80 nm and about 500 nm. In still other embodiments the mean particle size of the initial rubber substrate may be in a range of between about 200 nm and about 750 nm. In other embodiments the mean particle size of the initial rubber substrate may be greater than about 400 nm. In still other embodiments the initial rubber substrate comprises particles which are a mixture of particle sizes with at least two mean particle size distributions. In a particular embodiment the initial rubber substrate comprises particles which are a mixture of particle sizes with two mean particle size distributions each in a range of between about 80 nm and about 500 nm.

The rubber substrate may be made according to known methods. In one embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan and coagulated to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate and aryl-(meth)acrylate monomers, vinyl aromatic monomers and monoethylenically unsaturated nitrile monomers. Suitable (C₁-C₁₂)alkyl-(meth)acrylate and aryl-(meth)acrylate monomers, vinyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers.

The rigid thermoplastic phase typically comprises one or more vinyl aromatic polymers. Suitable vinyl aromatic polymers comprise at least about 20 wt. % structural units derived from one or more vinyl aromatic monomers. In one embodiment the rigid thermoplastic phase comprises a vinyl aromatic polymer having first structural units derived from one or more vinyl aromatic monomers and having second structural units derived from one or more monoethylenically unsaturated nitrile monomers. Examples of such vinyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises a vinyl aromatic polymer having first structural units derived from one or more vinyl aromatic monomers; second structural units derived from one or more monoethylenically unsaturated nitrile monomers; and third structural units derived from one or more monomers selected from the group consisting of (C₁-C₁₂)alkyl- and aryl-(meth)acrylate monomers. Examples of such vinyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable vinyl aromatic polymers comprise styrene/methylmethacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures. In a particular embodiment the rubber modified thermoplastic resin comprises an acrylate/styrene/acrylonitrile (ASA) resin wherein the rigid thermoplastic phase comprises either a styrene/acrylonitrile copolymer or a styrene/acrylonitrile/methyl methacrylate copolymer. In another particular embodiment the rubber modified thermoplastic resin comprises an acrylonitrile/butadiene/styrene (ABS) resin wherein the rigid thermoplastic phase comprises either a styrene/acrylonitrile copolymer or a styrene/acrylonitrile/methyl methacrylate copolymer.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt. % of the rigid thermoplastic phase is chemically grafted to the rubber, based on the total amount of rigid thermoplastic phase in the composition. In another embodiment, greater than about 15 wt. % of the rigid thermoplastic phase is chemically grafted to the rubber, based on the total amount of rigid thermoplastic phase in the composition. In still another embodiment, greater than about 20 wt. % of the rigid thermoplastic phase is chemically grafted to the rubber, based on the total amount of rigid thermoplastic phase in the composition. In particular embodiments the amount of rigid thermoplastic phase chemically grafted to the rubber may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of rigid thermoplastic phase in the composition. In yet other embodiments, about 40 wt. % to 90 wt. % of the rigid thermoplastic phase is free, that is, non-grafted.

The rigid thermoplastic phase may be present in the rubber modified thermoplastic resin of compositions of the invention in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the total weight of the rubber modified thermoplastic resin. In other embodiments rigid thermoplastic phase may be present in compositions of the invention in a range of between about 90 wt. % and about 30 wt. %, based on the total weight of the rubber modified thermoplastic resin.

The rigid thermoplastic phase may be formed solely by polymerization carried out in the presence of rubber substrate, or by addition of one or more separately synthesized rigid thermoplastic polymers to the rubber modified thermoplastic resin comprising the composition, or by a combination of both processes. In some embodiments the separately synthesized rigid thermoplastic polymer comprises structural units essentially identical to those of the rigid thermoplastic phase comprising the rubber modified thermoplastic resin. In some particular embodiments separately synthesized rigid thermoplastic polymer comprises at least one of styrene-acrylonitrile copolymer or styrene-acrylonitrile-methyl methacrylate copolymer. When at least a portion of separately synthesized rigid thermoplastic polymer is added to compositions, then the amount of said separately synthesized rigid thermoplastic polymer added is in one embodiment in an amount in a range of between about 5 wt. % and about 80 wt. % and in another embodiment in an amount in a range of between about 20 wt. % and about 80 wt. % based on the weight of the entire composition.

Two or more different rubber substrates, each possessing a different mean particle size, may be separately employed in a polymerization reaction to prepare rigid thermoplastic phase, and then the products blended together. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. Nos. 3,944,631; and European Patent Application 0913408. The unsaturated sites in the rubber phase are provided, for example, by unsaturated sites in those structural units of the rubber that were derived from a graftlinking monomer.

In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in U.S. Pat. No. 7,049,368. In the present context the change from one graft stage to the next is defined as that point where there is a change in the identity of at least one monomer added to the rubber substrate for grafting. In one embodiment formation of rigid thermoplastic phase and grafting to rubber substrate are performed by feeding at least one first monomer over time to a reaction mixture comprising rubber substrate. In this context a second graft stage occurs when a different monomer is introduced into the feed stream in the presence or absence of said first monomer.

In embodiments wherein staged monomer grafting to rubber substrate is used, at least two stages are employed for grafting, although additional stages may be employed. The first graft stage is performed with one or more monomers selected from the group consisting of vinyl aromatic monomers and monoethylenically unsaturated nitrile monomers. In a particular embodiment grafting is performed in a first stage with a mixture of monomers, at least one of which is selected from the group consisting of vinyl aromatic monomers and at least one of which is selected from the group consisting of monoethylenically unsaturated nitrile monomers. When at least one vinyl aromatic monomer and at least one monoethylenically unsaturated nitrile monomer are employed in the first graft stage, then the wt./wt. ratio of vinyl aromatic monomer to monoethylenically unsaturated nitrile monomer is in one embodiment in a range of between about 1:1 and about 6:1, in another embodiment in a range of between about 1.5:1 and about 4:1, in still another embodiment in a range of between about 2:1 and about 3:1, and in still another embodiment in a range of between about 2.5:1 and about 3:1. In one preferred embodiment the wt./wt. ratio of vinyl aromatic monomer to monoethylenically unsaturated nitrile monomer employed in the first graft stage is about 2.6:1.

In at least one subsequent stage following said first stage, grafting is performed with one or more monomers selected from the group consisting of (C₁-C₁₂)alkyl- and aryl-(meth)acrylate monomers, vinyl aromatic monomers and monoethylenically unsaturated nitrile monomers. In a particular embodiment grafting is performed in at least one subsequent stage with one or more monomers, at least one of which is selected from the group consisting of (C₁-C₁₂)alkyl- and aryl-(meth)acrylate monomers. In another particular embodiment grafting is performed in at least one subsequent stage with a mixture of monomers, at least one of which is selected from the group consisting of (C₁-C₁₂)alkyl- and aryl-(meth)acrylate monomers and at least one of which is selected from the group consisting of vinyl aromatic monomers and monoethylenically unsaturated nitrile monomers. In another particular embodiment grafting is performed in at least one subsequent stage with a mixture of monomers, one of which is selected from the group consisting of (C₁-C₁₂)alkyl- and aryl-(meth)acrylate monomers; one of which is selected from the group consisting of vinyl aromatic monomers and one of which is selected from the group consisting of monoethylenically unsaturated nitrile monomers. Said (C₁-C₁₂)alkyl- and aryl-(meth)acrylate monomers, vinyl aromatic monomers and monoethylenically unsaturated nitrile monomers include those described hereinabove.

In the first graft stage the amount of monomer employed for grafting to rubber substrate is in one embodiment in a range of between about 5 wt. % and about 98 wt. %; in another embodiment in a range of between about 5 wt. % and about 95 wt. %; in another embodiment in a range of between about 10 wt. % and about 90 wt. %; in another embodiment in a range of between about 15 wt. % and about 85 wt. %; in another embodiment in a range of between about 20 wt. % and about 80 wt. %; and in yet another embodiment in a range of between about 30 wt. % and about 70 wt. %, based on the total weight of monomer employed for grafting in all stages. In one particular embodiment the amount of monomer employed for grafting to rubber substrate in the first stage is in a range of between about 30 wt. % and about 95 wt. % based on the total weight of monomer employed for grafting in all stages. Further monomer is then grafted to rubber substrate in one or more stages following said first stage. In one particular embodiment all further monomer is grafted to rubber substrate in one second stage following said first stage.

When at least one (C₁-C₁₂)alkyl- and aryl-(meth)acrylate monomer is employed for grafting to rubber substrate in a stage following the first stage, then the amount of said (meth)acrylate monomer is in one embodiment in a range of between about 95 wt. % and about 2 wt. %; in another embodiment in a range of between about 80 wt. % and about 2 wt. %; in another embodiment in a range of between about 70 wt. % and about 2 wt. %; in another embodiment in a range of between about 50 wt. % and about 2 wt. %; in another embodiment in a range of between about 45 wt. % and about 2 wt. %; and in yet another embodiment in a range of between about 40 wt. % and about 5 wt. %, based on the total weight of monomers employed for grafting in all stages.

When a mixture of monomers comprising at least one (C₁-C₁₂)alkyl- and aryl-(meth)acrylate monomer is employed for grafting to rubber substrate in a stage following the first stage, then the wt./wt. ratio of said (meth)acrylate monomer to the totality of other monomers is in one embodiment in a range of between about 10:1 and about 1:10; in another embodiment in a range of between about 8:1 and about 1:8; in another embodiment in a range of between about 5:1 and about 1:5; in another embodiment in a range of between about 3:1 and about 1:3; in another embodiment in a range of between about 2:1 and about 1:2; and in yet another embodiment in a range of between about 1.5:1 and about 1:1.5.

Compositions of the invention may optionally comprise at least one polycarbonate. Polycarbonates useful in the compositions comprise structural units derived from at least one dihydroxy aromatic hydrocarbon. In various embodiments structural units derived from at least one dihydroxy aromatic hydrocarbon comprise at least about 60 percent of the total number of structural units derived from any dihydroxy-substituted hydrocarbon in the polycarbonates, and the balance of structural units derived from any dihydroxy-substituted hydrocarbon are aliphatic, alicyclic, or aromatic radicals.

In embodiments of the invention dihydroxy-substituted aromatic hydrocarbons from which structural units of polycarbonates may be derived comprise those represented by the formula (I):

HO---D---OH (I)

wherein D is a divalent aromatic radical. In some embodiments, D has the structure of formula (II):

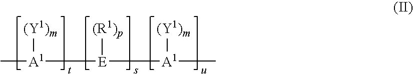

wherein A¹ represents an aromatic group including, but not limited to, phenylene, biphenylene, naphthylene and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (II) above, when more than one Y¹ substituent is present, they may be the same or different. The same holds true for the R¹ substituent. Where “s” is zero in formula (II) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dihydroxy-substituted aromatic hydrocarbons of this type include those of the formula (III):

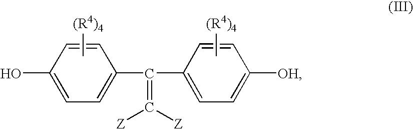

where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine.

Suitable dihydroxy-substituted aromatic hydrocarbons also include those of the formula (IV):

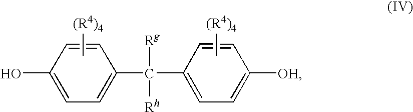

where independently each R⁴ is as defined hereinbefore, and independently R^{g} and R^{h} are hydrogen or a C₁₋₃₀ hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl)ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C₁₋₃ alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′ dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl) sulfone and bis(3,5-dimethylphenyl-4-hydroxyphenyl)sulfide; and the like. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (V), which compound is 3-(4-hydroxyphenyl)-1,1,3-trimethylindan-5-ol, and by the formula (VI), which compound is 1-(4-hydroxyphenyl)-1,3,3-trimethylindan-5-ol:

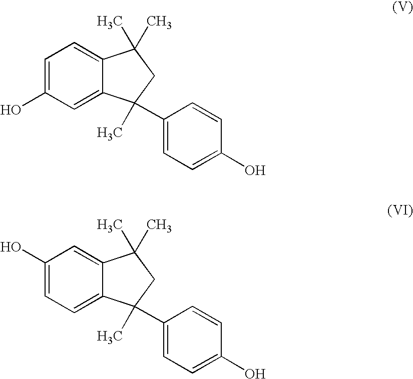

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (VII):

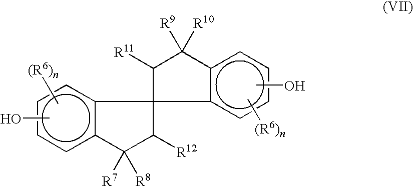

wherein each R⁶ is independently selected from monovalent hydrocarbon radicals and halogen radicals; each R⁷, R⁸, R⁹, and R¹⁰ is independently C₁₋₆ alkyl; each R¹¹ and R¹² is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures comprising at least one of any of the foregoing dihydroxy-substituted aromatic hydrocarbons may also be employed.

Polycarbonates of the invention further comprise structural units derived from at least one carbonate precursor. There is no particular limitation on the carbonate precursor. Phosgene or diphenyl carbonate are frequently used. There is no particular limitation on the method for making suitable polycarbonates. Any known process may be used. In some embodiments an interfacial process or a melt transesterification process may be used.

In one embodiment of the invention the optional polycarbonate comprises at least one homopolycarbonate, wherein the term “homopolycarbonate” refers to a polycarbonate synthesized using only one type of dihydroxy-substituted aromatic hydrocarbon. In particular embodiments the polycarbonate comprises a bisphenol A homo- or copolycarbonate, wherein the term “copolycarbonate” refers to a polycarbonate synthesized using more than one type of dihydroxy-substituted hydrocarbon, and in particular more than one type of dihydroxy-substituted aromatic hydrocarbon. In another particular embodiment the polycarbonate comprises a linear homopolycarbonate resin with structural units derived from bisphenol A. In other embodiments the polycarbonate comprises a blend of at least one first polycarbonate with at least one second polycarbonate differing from said first polycarbonate either in structural units, or in molecular weight, or in both these parameters.

In various embodiments the weight average molecular weight of the polycarbonate ranges from about 5,000 to about 200,000. In other particular embodiments the weight average molecular weight of the polycarbonate resin is in one embodiment from about 10,000 to about 200,000 grams per mole (“g/mol”), in another embodiment from about 17,000 to about 100,000 g/mol, in another embodiment from about 18,000 to about 80,000 g/mol, in another embodiment from about 18,000 to about 40,000 g/mol, in still another embodiment from about 18,000 to about 36,000 g/mol, in still another embodiment from about 18,000 to about 30,000 g/mol, and in still another embodiment from about 18,000 to about 23,000 g/mol, all as determined by gel permeation chromatography relative to polystyrene standards. In other embodiments the weight average molecular weight of the polycarbonate ranges from about 28,000 to about 36,000 g/mol. Suitable polycarbonate resins typically exhibit an intrinsic viscosity in one embodiment of about 0.1 to about 1.5 deciliters per gram, in another embodiment of about 0.35 to about 0.9 deciliters per gram, in another embodiment of about 0.4 to about 0.6 deciliters per gram, and in still another embodiment of about 0.48 to about 0.54 deciliters per gram, all measured in methylene chloride at 25° C.

In a polycarbonate-comprising blend there may an improvement in melt flow and/or other physical properties when one molecular weight grade of a polycarbonate is combined with a proportion of a relatively lower molecular weight grade of another polycarbonate. Therefore, the present invention encompasses compositions comprising only one molecular weight grade of a polycarbonate and also compositions comprising two or more molecular weight grades of polycarbonate. The two or more polycarbonates may comprise essentially the same or different structural units. When two or more molecular weight grades of polycarbonate are present, then the weight average molecular weight of the lowest molecular weight polycarbonate is in one embodiment about 10% to about 95%, in another embodiment about 40% to about 85%, and in still another embodiment about 60% to about 80% of the weight average molecular weight of the highest molecular weight polycarbonate. In one representative, non-limiting embodiment polycarbonate-containing blends include those comprising a polycarbonate with weight average molecular weight between about 18,000 and about 24,000 combined with a polycarbonate with weight average molecular weight between about 25,000 and about 30,000 (in all cases relative to polystyrene standards). In another representative, non-limiting embodiment polycarbonate-containing blends include those comprising a polycarbonate with weight average molecular weight between about 18,000 and about 23,000 combined with a polycarbonate with weight average molecular weight between about 28,000 and about 36,000 (in all cases relative to polystyrene standards). When two or more molecular weight grades of polycarbonate are present, the weight ratios of the various molecular weight grades may range from about 1 to about 99 parts of one molecular weight grade and from about 99 to about 1 parts of any other molecular weight grades. In some embodiments a mixture of two molecular weight grades polycarbonate is employed, in which case the weight ratios of the two grades may range in one embodiment from about 99:1 to about 1:99, in another embodiment from about 80:20 to about 20:80, and in still another embodiment from about 70:30 to about 50:50. Since not all manufacturing processes for making a polycarbonate are capable of making all molecular weight grades of that constituent, the present invention encompasses compositions comprising two or more molecular weight grades of polycarbonate in which each polycarbonate is made by a different manufacturing process. In one particular embodiment the instant invention encompasses compositions comprising a polycarbonate made by an interfacial process in combination with a polycarbonate of different weight average molecular weight made by a melt process.

When present in a composition of the present invention the amount of polycarbonate resin is in one embodiment greater than about 25 wt. %, preferably greater than about 35 wt. %, and more preferably greater than about 40 wt. %, based on the weight of the entire composition. In another embodiment the amount of polycarbonate present in a composition of the present invention is in a range of between about 35 wt. % and about 95 wt. %, in another embodiment in a range of between about 40 wt. % and about 85 wt. %, and in still another embodiment in a range of between about 50 wt. % and about 80 wt. %, based on the weight of the entire composition.

Compositions of the invention additionally comprise a plurality of microsphere beads having a diameter in a range of about 1 to about 1300 microns, typically in a range of about 1 to about 850 microns, and more typically in a range of about 10 to about 200 microns. In a particular embodiment, the beads are comprised of glass and have a diameter of about 50 microns. In a particular embodiment the beads are comprised of barium titanate. The microsphere beads typically have an index of refraction ranging from about 1.4 to about 2.5, and may be clear or colored. The beads may optionally further comprise a coating on at least a portion of their surface to enhance reflectivity in the microsphere bead. In a particular embodiment the beads are coated on approximately half of the bead surface forming hemispherical reflectors. In other particular embodiments the beads are coated with a metallic material, such as aluminum, or a non-metallic material, such as an organic compound or ceramic, to enhance reflectivity. Suitable microsphere beads include, but are not limited to, those available from Prizmalite Industries New York, N.Y.; those available from 3M Company, St. Paul, Minn.; and those available from Swarco REFLEX Inc., Mexia, Tex.

The amount of microsphere beads present in compositions of the invention is an effective amount to provide special visual effect surface properties to an article made from the composition. Special visual effect surface properties may be measured by known optical techniques such as by measuring image texture value. Image texture value is typically measured by digitally acquiring images from the surface of molded plaques comprising compositions of the invention. The sample area to be examined is a flat surface with dimensions in a range of at least 5 centimeters (cm)×5 cm (minimum) and no more than 50 cm×50 cm (maximum). Said plaques are illuminated so that the incident light beam falls on the plaque at a 45 degree angle with respect to the surface normal and at the center of the field of interest. A digital imaging device is positioned behind the light source so that the focal plane of the device is normal to the axis of the incident light beam and the line of sight is collinear with the light source. A light meter is used to increase the intensity of light so that the brightest pixels are near the saturation point of the imaging device but do not exceed the saturation point. Using the acquired image, the image texture value is quantified as the average deviation of each pixel's intensity from the mean baseline intensity of the pixel's background. For comparison a monochromatic molded plaque is prepared containing no microsphere beads, mineral flakes, metallic pigment or other special visual effects additive. The comparison plaque has an image texture value of essentially zero since there is no deviation of individual pixel intensity from the mean intensity of the surface within the area measured, as light is reflected from each element of the entire plaque surface in essentially the same manner. A surface of an article formed from a composition of the invention exhibits in one embodiment an image texture value of at least 2, in another embodiment an image texture value of at least 2.5 and in still another embodiment an image texture value of at least 3. In still other embodiments a surface of an article formed from a composition of the invention exhibits an image texture value in a range of 2 to 30, wherein in each case the image texture value is quantified as the average deviation of pixel intensity from the mean intensity for the area measured. Using the same apparatus and measurement method, the image texture value may also be quantified as the number (or percentage) of pixels (or clusters of pixels) having values above a specified threshold (sometimes referred to as bright spots per specified number of pixels). Image texture value is related semi-quantitatively to metallic sparkle effect since the higher the image texture value, the more intense the observed metallic sparkle effect.

In some particular embodiments the amount of microsphere beads present in a composition is in a range of between about 1 part per hundred parts resin (phr) and about 14 phr, in another embodiment in a range of between about 2 phr and about 12 phr. and in another embodiment in a range of between about 2 phr and about 10 phr. In other particular embodiments the amount of microsphere beads present in a composition is between about 2 phr and about 7 phr, or between about 2 phr and about 4 phr.

Compositions of the invention optionally comprise at least one image texture enhancing agent. Suitable image texture enhancing agents generally comprise surfactants with amphiphilic or surfactant characteristics. Illustrative examples of suitable image texture enhancing agents comprise poly(acrylic acid), poly(methacrylic acid), poly(vinyl alcohol), ethylene-acrylic acid copolymers, ethylene-methacrylic acid copolymers, and their ammonium, calcium, magnesium, potassium, sodium, lithium, and zinc partial salts; ethylene-methacrylic acid-vinyl acetate copolymers and their ammonium, calcium, magnesium, potassium, sodium, and zinc partial salts; methacrylic acid copolymers with ethylene and isobutyl acrylate and their potassium, sodium and zinc partial salts; polymers comprising sulfonic acid and/or sulfonate salt structural units; sodium lauryl sulfate, and the like, and mixtures thereof. In some embodiments compositions of the invention comprise ethylene-acrylic acid copolymers with acrylic acid level in a range of between about 2.0% and about 22%, and having a melt index in a range of between about 1 gram per 10 minutes and about 1500 grams per 10 minutes. Suitable ethylene-acrylic acid copolymers include, but are not limited to, PRIMACOR® ethylene-acrylic acid copolymers available from Dow Chemical Co. In other embodiments compositions of the invention comprise ethylene-methacrylic acid copolymers typically having a melt flow index in a range of between about 0.5 grams per 10 minutes and about 70 grams per 10 minutes. In some embodiments suitable ethylene-methacrylic acid copolymers may optionally have varying degree of neutralization with one or more counterions such as ammonium, calcium, magnesium, zinc, potassium, sodium, or lithium, and may have a melt flow index in a range of between about 0.7 grams per 10 minutes and about 450 grams per 10 minutes. Suitable ethylene-methacrylic acid copolymers include, but are not limited to, SURLYN® NUCREL® ethylene-methacrylic acid copolymers available from Dupont Co.

The amount of optional image texture enhancing agent in compositions of the invention is an amount effective to increase image texture from the surface of a molded part in comparison to the corresponding image texture from the surface of a molded part made from a composition not containing said image texture enhancing agent. In some embodiments the image texture enhancing agent is present in an amount in a range of between about 0.1 phr and about 10 phr, and in other embodiments in an amount in a range of between about 0.5 phr and about 6 phr.

Compositions of the present invention may optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, and metal fibers. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers and mixtures thereof.

In another particular embodiment compositions of the invention may optionally comprise a plurality of refracting elements to provide special visual effects, which elements may comprise material which is either glass, ceramic, or polymeric. The refracting elements can be of any desired shape in horizontal cross section such as ellipsoidal, semicircular, oblong, rectangular, irregular, regular, etc. In some embodiments the horizontal cross section of the refracting elements is preferably substantially circular. In some embodiments at least a portion of refracting element will be exposed at the surface of an article made from a composition of the invention. In other embodiments it is preferred that the refracting elements are in the range of about 0.2 to about 6.0 millimeters (mm) in height, more preferably about 1 to about 4 mm, and in the range of 1 to 20 mm in diameter when rounded in horizontal cross section. Also, it is often desirable to have the average width of the refracting element at the base equal to about 2 to 5 times the average height of the refracting elements. One ideal shape of the refracting elements is a hemisphere or some percentage thereof.

In another particular embodiment compositions of the invention may optionally comprise mineral flakes or metallic pigment which may be in the form of flakes to provide special visual effects. The metallic pigment typically has a mean particle size ranging from about 1 to about 3500 microns, preferably from about 1 to about 500 microns, preferably from about 30 to about 300 microns, and still more preferably from about 10 to about 80 microns. The preferred mineral flakes are mica flakes. Preferred metallic pigments are based on metals of Groups 4, 6, 8, 9, 10, 11, 13, and 14 of the periodic table of the elements. Examples of these metallic pigments include aluminum, bronze, brass, chromium, copper, gold, iron, molybdenum, nickel, tin, titanium, zinc and the like. A “cornflake” type or corrugated irregularly shaped planar flake of aluminum or bronze may be utilized, although a “silver dollar” type or a circular planar type of flake may also be utilized as metallic pigment. Glitter, which is a special type of aluminum pigment produced from foil, may also be utilized. The foil, typically rolled to gauges of less than 0.025 mm, is typically cut into square, rectangular or hexagonal shapes in sizes from 0.2 to about 3 mm, and typically coated with a transparent epoxy lacquer to halt oxidative dulling of the foil. Glitter, with its large particle sizes, can produce discrete highlights of metallic sparkle. Gold bronzes are typically alloys of copper and zinc with a small amount of aluminum to reduce oxidation. The range of gold colors is produced by varying proportions of major alloy components. The green gold alloy typically contains 70 percent copper, and color becomes redder as the percentage of copper is increased; 90 percent copper produces pale gold; deep gold is made by controlled oxidation of the alloys. Gold bronzes are usually utilized in flake form, with coarser grades giving more brilliance. Metallic flakes such as copper must be utilized with care, however, as they may be susceptible to heat, moisture and corrosives. The metallic pigment may optionally be coated, for example, with rosin or fatty acids, such as oleic or linoleic acid. Optionally, the metallic pigment may be initially in granular form comprising a carrier, which may comprise at least one polymer. In granular form the metallic pigment typically represents about 70-80% of the granule with the remainder being the carrier. Said pigments can be used to produce or enhance bright sparkle as well as hammer and leafing finishes in articles prepared from compositions of the invention. In typical embodiments, wherein metallic pigments and/or mineral flakes are present, they are used in an amount of about 0.3 to about 7 wt. % based on the weight of the entire composition, with about 0.5 to about 5.0 wt. % being preferred. Illustrative examples of suitable metallic pigments comprise those with the tradename SILVET® aluminum pigment available from Silberline Manufacturing Co., Tamaqua, Pa.

The compositions of the present invention can be formed into useful articles. In some embodiments the articles comprise unitary articles. In still other embodiments the articles may comprise a sheet or film comprising a composition of the present invention. In other embodiments the articles may comprise a multilayer article comprising at least one layer comprising a composition of the present invention. Suitable articles include, but are not limited to, those typically used in applications requiring special visual effect surface properties and/or weatherable properties. Some particular suitable articles comprise outdoor and indoor signs, highway signs, traffic signs, horizontal signs, surface markers, guard rails, Jersey barriers; traffic barrels, tubes, and cones; and pavement or road markers and lines.

Additional articles which can be made which comprise compositions of the present invention include, but are not limited to, articles for outdoor vehicle and device (OVAD) applications; exterior and interior components for aircraft, automotive, truck, military and emergency vehicles (including automotive, aircraft, and water-borne vehicles), scooter, and motorcycle, including panels, quarter panels, rocker panels, vertical panels, horizontal panels, trim, pillars, center posts, fenders, doors, decklids, trunklids, hoods, bonnets, roofs, fascia, grilles, mirror housings, pillar appliques, cladding, body side moldings, wheel covers, door handles, spoilers, window frames, headlamp bezels, tail lamp housings, tail lamp bezels, license plate enclosures, and roof racks; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, fencing, decking planks, roofs; siding, particularly vinyl siding applications; windows, floors, decorative window furnishings or treatments; wall panels, and doors; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; mobile phone housings; radio sender housings; radio receiver housings; light fixtures; lighting appliances; reflectors; network interface device housings; transformer housings; air conditioner housings; cladding or seating for public transportation; cladding or seating for trains, subways, or buses; meter housings; antenna housings; cladding for satellite dishes; and like applications.

Articles comprising compositions of the invention may be prepared by known thermoplastic processing techniques. In a particular embodiment articles may be made by a method comprising the steps of (i) adding to the resinous composition a plurality of microsphere beads having a diameter in a range of about 1 to about 1300 microns and having an index of refraction ranging from about 1.4 to about 2.5; (ii) compounding the composition with intimate mixing; and (iii) forming the article therefrom. Known thermoplastic processing techniques which may be used for forming the article, include, but are not limited to, extrusion, kneading, profile extrusion, sheet extrusion, coextrusion, molding, extrusion blow molding, thermoforming, injection molding, co-injection molding and rotomolding. The invention further contemplates additional fabrication operations on said articles, such as, but not limited to, in-mold decoration, baking in a paint oven, surface etching, lamination, and/or thermoforming. In a preferred embodiment articles of the invention are made by an injection molding process. Microspheres migrate to the surface of the molded parts from within during the article fabrication process. Thus, only a portion of the plurality of microsphere beads is present at the article's surface. As such, the amount of reflectivity varies with processing conditions employed to make the article. The fabrication process may be optimized, without undue experimentation, to produce the maximum image texture value for the surface of the molded part. Surprisingly, it has been found that articles prepared by injection molding at lower mold set temperature have a higher value for image texture and, hence enhanced aesthetic attractiveness, than articles molded at high mold set temperature. In a particular embodiment articles of the invention are prepared by injection molding at a mold set temperature of less than about 180° C., preferably less than about 160° C., more preferably less than about 140° C., and still more preferably less than about 120° C. In other particular embodiments articles of the invention are prepared by injection molding at a mold set temperature in a range of 90° C. to 160° C. or 100° C. to 140° C.

In addition to compositions comprising rubber modified thermoplastic resins and their blends with polycarbonate, compositions comprising other thermoplastic resins may be made by the method of the present invention and exhibit special visual effects. Illustrative examples of such equivalent thermoplastics comprise polyesters, such as poly(alkylene terephthalates), poly(alkylene naphthalates), poly(ethylene terephthalate), poly(butylene terephthalate), poly(trimethylene terephthalate), poly(ethylene naphthalate), poly(butylene naphthalate), poly(cyclohexanedimethanol terephthalate), poly(cyclohexanedimethanol-co-ethylene terephthalate), poly(1,4-cyclohexane-dimethyl-1,4-cyclohexanedicarboxylate), polyarylates, the polyarylate with structural units derived from resorcinol and a mixture of iso- and terephthalic acids, polyestercarbonates, the polyestercarbonate with structural units derived from bisphenol A, carbonic acid and a mixture of iso- and terephthalic acids, the polyestercarbonate with structural units derived from resorcinol, carbonic acid and a mixture of iso- and terephthalic acids, and the polyestercarbonate with structural units derived from bisphenol A, resorcinol, carbonic acid and a mixture of iso- and terephthalic acids; thermoplastic elastomers such as polyesters containing soft-block segments including those provided under the tradenames HYTREL®, LOMOD®, PEBAX®, PELPRENE®, and the like; and polycarbonates such as those described herein above. Representative thermoplastics also comprise aromatic polyethers such as polyarylene ether homopolymers and copolymers such as those comprising 2,6-dimethyl-1,4-phenylene ether units, optionally in combination with 2,3,6-trimethyl-1,4-phenylene ether units. Suitable aromatic polyethers also comprise polyetherimides, polyetherketones, polyetheretherketones, and polyethersulfones. Representative thermoplastics also comprise polyarylene sulfides and sulfones, such as polyphenylene sulfides, polyphenylene sulfones, and copolymers of polyphenylene sulfides with polyphenylene sulfones. Representative thermoplastics also comprise polyamides, such as poly(hexamethylene adipamide) and poly(ε-aminocaproamide). Representative thermoplastics also comprise polyolefin homopolymers and copolymers, such as polyethylene, polypropylene, copolymers containing at least one of ethylene and propylene, polyacrylates, polymethylmethacrylate, poly(ethylene-co-acrylate)s including SURLYN, polystyrene including syndiotactic polystyrene, poly(styrene-co-acrylonitrile), and poly(styrene-co-maleic anhydride). Compatibilized blends of materials containing at least one of any of the aforementioned thermoplastic materials are also suitable. For example impact modified blends of any of the aforementioned materials may be employed, such as thermoplastic polyolefin (TPO). Illustrative blends comprise poly(phenylene ether)-polystyrene, poly(phenylene ether)-polyamide, poly(phenylene ether)-polyester, poly(butylene terephthalate)-polycarbonate, poly(ethylene terephthalate)-polycarbonate, polycarbonate-polyetherimide, and polyester-polyetherimide.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

The following examples and comparative examples the various components included: (i) PRIZMALITE® 2453BTA barium titanate glass microsphere beads having an average diameter of about 47 microns, a refractive index of about 1.9 and comprising a thin aluminum coat on approximately one-half of the bead surface (available from Prizmalite Industries New York, N.Y.); (ii) SILVET® 440-30-E1 aluminum pigment in a carrier matrix available from Silberline Manufacturing Co. (Tamaqua, Pa.); and (iii) PRIMACOR® ethylene-acrylic acid copolymer grade 5990I available from Dow Chemical Co. with acrylic acid level of 20% and melt index of 1300 grams per 10 minutes. Except as noted for relative wt. % values, all wt. % values are based on the weight of the entire composition.

### Example 1

A composition is prepared comprising (i) 54.6 wt. % ASA resin comprising 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55); and (ii) 36.4 wt. % MMASAN resin comprising structural units derived from 35 wt. % methyl methacrylate (MMA), 40 wt. % styrene (S), and 25 wt. % acrylonitrile (AN). In addition each composition comprises 3.6 wt. % PRIZMALITE microsphere beads, 2.7 wt. % SILVET shredded aluminum flakes in a carrier, and 0.9 wt. % N,N′-ethylenebisstearamide. Each composition also comprises 0.2 wt. % carbon black, about 0.2 wt. % other pigments, and about 1.3 wt. % total of hindered phenolic antioxidants, hindered amine light stabilizers, UV absorbers, and phosphite stabilizers. In addition certain compositions comprise 2 phr of PRIMACOR ethylene-acrylic acid copolymer. Compositions are compounded and then molded into test parts. The surface of molded parts made from a composition not containing PRIMACOR displays acceptable brightness as measured by image texture value. A composition without PRIMACOR displays an image texture value of about 2.5 when parts are molded at 180° C. mold set temperature and an image texture value of about 4.3 when parts are molded at about 100° C. mold set temperature. In contrast a composition comprising PRIMACOR displays an image texture value of about 3 when parts are molded at 180° C. mold set temperature and an image texture value of about 7 when parts are molded at about 100° C. mold set temperature.

### Comparative Example 1

A composition is prepared as in Example 1 except without the addition of microsphere beads, mineral flakes, metallic pigment or other special visual effects additive. The comparison plaque has an image texture value of essentially zero. There is no deviation of individual pixel intensity from the mean intensity of the surface within the area measured, as light is reflected from each element of the entire plaque surface in essentially the same manner.

### Example 2

A composition is prepared comprising (i) 54.6 wt. % ASA resin comprising 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55); and (ii) 36.4 wt. % MMASAN resin comprising structural units derived from 35 wt. % methyl methacrylate (MMA), 40 wt. % styrene (S), and 25 wt. % acrylonitrile (AN). In addition the composition comprises (iii) 4 phr microsphere beads (reflective glass elements type 7240, barium titanate glass microsphere beads available from 3M Company, with 1.9 refractive index and average diameter of about 45 microns, with a typical range of about 25-60 microns); (iv) 2.7 wt. % SILVET shredded aluminum flakes in a carrier, and (v) 0.9 wt. % N,N′-ethylenebisstearamide. Each composition also comprises 0.2 wt. % carbon black, about 0.2 wt. % other pigments, and about 1.3 wt. % total of hindered phenolic antioxidants, hindered amine light stabilizers, UV absorbers, and phosphite stabilizers. In addition certain compositions comprise 2 phr of PRIMACOR ethylene-acrylic acid copolymer. Compositions are compounded and then molded into test parts. The surface of molded parts made from a composition not containing PRIMACOR displays acceptable brightness as measured by image texture value. A composition without PRIMACOR displays an image texture value of about 3 when parts are molded at 180° C. mold set temperature and an image texture value of about 5 when parts are molded at about 100° C. mold set temperature. In contrast a composition comprising PRIMACOR displays an image texture value of about 4 when parts are molded at 180° C. mold set temperature and an image texture value of about 8 when parts are molded at about 100° C. mold set temperature.

### Example 3

A composition is prepared comprising (i) 22 wt. % ASA resin comprising 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55); (ii) 12.9 wt. % MMASAN resin comprising structural units derived from 35 wt. % methyl methacrylate (MMA), 40 wt. % styrene (S), and 25 wt. % acrylonitrile (AN); and (iii) 44.9 wt. % of a bisphenol A polycarbonate with a weight average molecular weight between about 25,000 and about 30,000 as determined by gel permeation chromatography relative to polystyrene standards. In addition the composition comprises (iv) 3 phr glass beads PRIZMALITE microsphere beads; (v) 3 phr SILVET shredded aluminum flakes in a carrier; (vi) 5 wt. % of a copolymer derived from methyl methacrylate and butyl acrylate; and (vii) 14.8 wt. % poly(methyl methacrylate). Each composition also comprises 0.2 phr carbon black, about 0.2 phr other pigments, and about 0.3 wt. % total of additives and stabilizers. In addition a comparative composition was prepared not containing glass beads. Compositions are compounded and then molded into test parts. The surface of molded parts made from a composition containing glass beads displays acceptable sparkle effect as measured by image texture value in comparison to the surface of molded parts made from a composition not containing glass beads.

### Example 4

A composition is prepared comprising (i) 58.6 wt. % ASA resin comprising 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55); and (ii) 39 wt. % MMASAN resin comprising structural units derived from 35 wt. % methyl methacrylate (MMA), 40 wt. % styrene (S), and 25 wt. % acrylonitrile (AN). In addition each composition comprises various amounts of PRIZMALITE microsphere beads, 3 phr SILVET shredded aluminum flakes in a carrier, and 1 wt. % N,N′-ethylenebisstearamide. Each composition also comprises minor amounts of carbon black and other pigments, and about 1.35 wt. % total of hindered phenolic antioxidants, hindered amine light stabilizers, UV absorbers, and phosphite stabilizers. Compositions are compounded and then extruded into sheet 0.05 centimeters (cm) thick and 15 cm wide. Image texture data are then obtained from the “polish roll” side of the sheet. Test samples show the following image texture values at specific loading of microsphere beads: 12.1 at bead loading of 4 phr; 19.7 at bead loading of 8 phr; and 27.6 at bead loading of 12 phr.

### Example 5

A composition is prepared comprising (i) 60 wt. % ASA resin comprising 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55); and (ii) 40 wt. % MMASAN resin comprising structural units derived from 35 wt. % methyl methacrylate (MMA), 40 wt. % styrene (S), and 25 wt. % acrylonitrile (AN). In addition each composition comprises various amounts of PRIZMALITE microsphere beads, various amounts of SILVET shredded aluminum flakes in a carrier, and a common additive and pigment package. Compositions are compounded and then molded into test parts by injection molding at 140° C. mold set temperature. Table 1 shows surface optical data from the various compositions as bright spots per million pixels (with duplicate determinations shown in parentheses). Bright spots per million pixels were determined in a similar manner to image texture values.

TABLE 1

| Al flake | Microsphere beads | Bright spots per |
|---|---|---|
| amount (phr) | amount (phr) | million pixels |
| 0 | 0 | 0 (2) |
| 0 | 5 | 31 (38) |
| 5 | 0 | 32 (33) |
| 5 | 5 | 201 (246) |

### Example 6

A composition is prepared comprising (i) ABS resin and optionally (ii) either MMASAN or SAN resin. In addition the composition comprises (iii) microsphere beads; (iv) shredded aluminum flakes optionally in a carrier, and (v) a mixture of one or more pigments, lubricants, hindered phenolic antioxidants, hindered amine light stabilizers, UV absorbers, and/or phosphite stabilizers. In addition certain compositions comprise ethylene-acrylic acid copolymer. Compositions are compounded and then molded into test parts. The surface of a molded part made from a composition made either with or without ethylene-acrylic acid copolymer displays a higher image texture value than the surface of a molded part made from a comparative composition not containing microsphere beads, mineral flakes, metallic pigment or other special visual effects additive. The surface of a molded part made from a composition with ethylene-acrylic acid copolymer displays a higher image texture value than the surface of a molded part made from the same composition not containing ethylene-acrylic acid copolymer.

### Example 7

A composition is prepared comprising (i) ASA resin; (ii) bisphenol A polycarbonate resin and optionally (iii) either MMASAN or SAN resin. In addition the composition comprises (iv) microsphere beads; (v) shredded aluminum flakes optionally in a carrier, and (vi) a mixture of one or more pigments, lubricants, hindered phenolic antioxidants, hindered amine light stabilizers, UV absorbers, and/or phosphite stabilizers. In addition certain compositions comprise ethylene-acrylic acid copolymer. Compositions are compounded and then molded into test parts. The surface of a molded part made from a composition made either with or without ethylene-acrylic acid copolymer displays a higher image texture value than the surface of a molded part made from a comparative composition not containing microsphere beads, mineral flakes, metallic pigment or other special visual effects additive. The surface of a molded part made from a composition with ethylene-acrylic acid copolymer displays a higher image texture value than the surface of a molded part made from the same composition not containing ethylene-acrylic acid copolymer.

### Example 8

A composition is prepared comprising (i) ABS resin; (ii) bisphenol A polycarbonate resin and optionally (iii) either MMASAN or SAN resin. In addition the composition comprises (iv) microsphere beads; (v) shredded aluminum flakes optionally in a carrier, and (vi) a mixture of one or more pigments, lubricants, hindered phenolic antioxidants, hindered amine light stabilizers, UV absorbers, and/or phosphite stabilizers. In addition certain compositions comprise ethylene-acrylic acid copolymer. Compositions are compounded and then molded into test parts. The surface of a molded part made from a composition made either with or without ethylene-acrylic acid copolymer displays a higher image texture value than the surface of a molded part made from a comparative composition not containing microsphere beads, mineral flakes, metallic pigment or other special visual effects additive. The surface of a molded part made from a composition with ethylene-acrylic acid copolymer displays a higher image texture value than the surface of a molded part made from the same composition not containing ethylene-acrylic acid copolymer.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and patent applications cited herein are incorporated herein by reference.

1. A composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and (ii) a plurality of microsphere beads having a diameter in a range of about 1 to about 1300 microns and having an index of refraction ranging from about 1.4 to about 2.5, wherein the microsphere beads are present in the composition in an amount in a range of between about 1 phr and about 14 phr, and wherein the microsphere beads provide a special visual effect on the surface of an article made from the composition.

2. The composition of claim 1, wherein the elastomeric phase comprises a polymer having structural units derived from at least one (C₁-C₁₂)alkyl(meth)acrylate monomer or from at least one conjugated diene monomer.

3. The composition of claim 2, wherein the elastomeric phase comprises a polymer having structural units derived from butyl acrylate.

4. The composition of claim 3, wherein the polymer of the elastomeric phase further comprises structural units derived from at least one polyethylenically unsaturated monomer.

5. The composition of claim 4, wherein the polyethylenically unsaturated monomer is selected from the group consisting of butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallylisocyanurate, triallylcyanurate, the acrylate of tricyclodecenylalcohol and mixtures thereof.

6. The composition of claim 2, wherein the elastomeric phase comprises a polymer having structural units derived from butadiene.

7. The composition of claim 1, wherein the elastomeric phase comprises about 10 wt. % to about 80 wt. % of the rubber modified thermoplastic resin.

8. The composition of claim 1, wherein the elastomeric phase comprises about 35 wt. % to about 80 wt. % of the rubber modified thermoplastic resin.

9. The composition of claim 1, wherein at least about 5 wt. % to about 90 wt. % of rigid thermoplastic phase is chemically grafted to the elastomeric phase, based on the total amount of rigid thermoplastic phase in the composition.

10. The composition of claim 1, wherein the rigid thermoplastic phase comprises structural units derived from a mixture of monomers selected from the group consisting of vinyl aromatic monomers, monoethylenically unsaturated nitrile monomers, (C₁-C₁₂)alkyl- and aryl-(meth)acrylate monomers, and mixtures thereof.

11. The composition of claim 1, wherein the rigid thermoplastic phase comprises structural units derived from styrene and acrylonitrile; or styrene, acrylonitrile, and methyl methacrylate; or alpha-methyl styrene, acrylonitrile and methyl methacrylate; or styrene, alpha-methyl styrene, acrylonitrile and methyl methacrylate.

12. The composition of claim 11, wherein the wt./wt. ratio of styrene, alpha-methyl styrene or mixture thereof to acrylonitrile is in a range of between about 1.5:1 and about 4:1.

13. The composition of claim 12, wherein the wt./wt. ratio of styrene, alpha-methyl styrene or mixture thereof to acrylonitrile is in a range of between about 2:1 and about 3:1.

14. The composition of claim 11, wherein the wt./wt. ratio of methyl methacrylate to the total of vinyl aromatic monomer and monoethylenically unsaturated nitrile monomer is in a range of between about 3:1 and about 1:5.

15. The composition of claim 1, wherein at least a portion of rigid thermoplastic phase is prepared in a separate polymerization step and added to the rubber modified thermoplastic resin.

16. The composition of claim 15, wherein the portion of rigid thermoplastic phase prepared in a separate polymerization step comprises structural units derived from styrene and acrylonitrile.

17. The composition of claim 15, wherein the portion of rigid thermoplastic phase prepared in a separate polymerization step comprises structural units derived from styrene, acrylonitrile and methyl methacrylate.

18. The composition of claim 15, wherein the portion of rigid thermoplastic phase prepared in a separate polymerization step is present in an amount of between about 5 wt. % and about 80 wt. % based on the weight of the entire composition.

19. The composition of claim 1, further comprising at least one polycarbonate.

20. The composition of claim 19, wherein at least one polycarbonate comprises structural units derived from bisphenol A.

21. The composition of claim 19, wherein the polycarbonate is present in an amount in a range of between about 35 wt. % and about 95 wt. %, based on the weight of the entire composition.

22. The composition of claim 1, wherein the microsphere beads are coated on at least a portion of their surface with at least one material selected from the group consisting of a metallic material, aluminum, a non-metallic material, a ceramic and an organic compound.

23. The composition of claim 22, wherein the microsphere beads are coated on approximately half of the bead surface forming hemispherical reflectors.

24. The composition of claim 1, wherein the microsphere beads are comprised of barium titanate.

25. The composition of claim 1, further comprising an additive selected from the group consisting of mineral flakes, metallic flakes, colorants, dyes, pigments, lubricants, stabilizers, fillers and mixtures thereof.

26. The composition of claim 25, wherein at least one additive is an aluminum pigment.

27. The composition of claim 26, wherein the aluminum pigment is present in an amount of about 0.3 to about 7 wt. % based on the weight of the entire composition.

28. The composition of claim 1, further comprising at least one image texture enhancing agent selected from the group consisting of poly(acrylic acid), poly(methacrylic acid), poly(vinyl alcohol), ethylene-acrylic acid copolymers, ethylene-methacrylic acid copolymers and their ammonium, calcium, magnesium, potassium, sodium, lithium, and zinc partial salts; ethylene-methacrylic acid-vinyl acetate copolymers and their ammonium, calcium, magnesium, potassium, sodium, and zinc partial salts; ethylene-methacrylic acid-isobutyl acrylate copolymers and their potassium, sodium and zinc partial salts; polymers comprising sulfonic acid or sulfonate salt structural units; sodium lauryl sulfate, and mixtures thereof.

29. The composition of claim 28, wherein the image texture enhancing agent is selected from the group consisting of poly(acrylic acid), poly(vinyl alcohol), ethylene-acrylic acid copolymers, sodium lauryl sulfate, and mixtures thereof.

30. The composition of claim 28, wherein the image texture enhancing agent is present in an amount in a range of between about 0.1 phr and about 10 phr.

31. A composition comprising: (i) a rubber modified thermoplastic resin comprising about 35 to about 70 wt. % based on the total weight of the resin of an elastomeric phase comprising structural units derived from either butyl acrylate or butadiene, wherein the elastomeric phase is dispersed in a rigid thermoplastic phase, wherein at least a portion of the rigid thermoplastic phase is grafted to the elastomeric phase, and wherein the rigid thermoplastic phase comprises structural units derived from a monomer mixture comprising styrene and acrylonitrile or, from a monomer mixture comprising styrene, acrylonitrile and methyl methacrylate, wherein styrene and acrylonitrile are employed in a wt./wt. ratio in a range of between about 1.5:1 and about 4:1, and the wt./wt. ratio of methyl methacrylate to the total of styrene and acrylonitrile is in a range of between about 3:1 and about 1:5; (ii) a plurality of microsphere beads present in an amount in a range of between about 1 phr and about 14 phr and having a diameter in a range of about 1 to about 1300 microns and having an index of refraction ranging from about 1.4 to about 2.5, wherein the microsphere beads provide a special visual effect on the surface of an article made from the composition; and (iii) an additive selected from the group consisting of mineral flakes, metallic flakes, colorants, dyes, pigments, lubricants, stabilizers, fillers and mixtures thereof.

32. The composition of claim 31, further comprising at least one polycarbonate present in an amount in a range of between about 35 wt. % and about 95 wt. %, based on the weight of the entire composition.

33. The composition of claim 32, wherein at least one polycarbonate comprises structural units derived from bisphenol A.

34. The composition of claim 31, further comprising at least one image texture enhancing agent selected from the group consisting of poly(acrylic acid), poly(vinyl alcohol), ethylene-acrylic acid copolymers, sodium lauryl sulfate, and mixtures thereof, present in an amount in a range of between about 0.1 phr and about 10 phr.

35. The composition of claim 31, wherein at least a portion of rigid thermoplastic phase is prepared in a separate polymerization step and added to the rubber modified thermoplastic resin.

36. The composition of claim 35, wherein the portion of rigid thermoplastic phase prepared in a separate polymerization step comprises structural units derived from either styrene and acrylonitrile or styrene, acrylonitrile and methyl methacrylate.

37. The composition of claim 35, wherein the portion of rigid thermoplastic phase prepared in a separate polymerization step is present in an amount of between about 5 wt. % and about 80 wt. % based on the weight of the entire composition.

38. The composition of claim 31, wherein at least one additive is an aluminum pigment present in an amount of about 0.3 to about 7 wt. % based on the weight of the entire composition.

39. An article having a metallic sparkle effect made from the composition of claim 1.

40. The article of claim 39 made by a process of injection molding wherein the mold set temperature is in a range of 90° C. to 160° C.

41. An article having a metallic sparkle effect made from the composition of claim 31.

42. The article of claim 41 made by a process of injection molding wherein the mold set temperature is in a range of 90° C. to 160° C.

43. A method for providing a special visual effect to the surface of a thermoplastic article, wherein the article comprises a composition comprising: a rubber modified thermoplastic resin comprising a discontinuous elastomeric phase dispersed in a rigid thermoplastic phase, wherein at least a portion of the rigid thermoplastic phase is grafted to the elastomeric phase;
wherein the method comprises the steps of (i) adding to the composition a plurality of microsphere beads in an amount in a range of between about 1 phr and about 14 phr, said beads having a diameter in a range of about 1 to about 1300 microns and having an index of refraction ranging from about 1.4 to about 2.5 wherein the microsphere beads provide a special visual effect on the surface of the article; (ii) compounding the composition with intimate mixing; and (iii) forming the article therefrom, wherein only a portion of the plurality of microsphere beads is present at the surface of the article, and wherein the surface of said article exhibits an image texture value of at least 2.5.

44. The method of claim 43, wherein the rubber modified thermoplastic resin comprises about 35 to about 70 wt. % based on the total weight of the resin of an elastomeric phase comprising structural units derived from either butyl acrylate or butadiene, wherein the elastomeric phase is dispersed in a rigid thermoplastic phase, wherein at least a portion of the rigid thermoplastic phase is grafted to the elastomeric phase, and wherein the rigid thermoplastic phase comprises structural units derived from a monomer mixture comprising styrene and acrylonitrile, or styrene, acrylonitrile and methyl methacrylate, wherein styrene and acrylonitrile are employed in a wt./wt. ratio in a range of between about 1.5:1 and about 4:1, and the wt./wt. ratio of methyl methacrylate to the total of styrene and acrylonitrile is in a range of between about 3:1 and about 1:5.

45. The method of claim 43, wherein the composition further comprises at least one image texture enhancing agent selected from the group consisting of poly(acrylic acid), poly(vinyl alcohol), ethylene-acrylic acid copolymers, sodium lauryl sulfate, and mixtures thereof, present in an amount in a range of between about 0.1 phr and about 10 phr.

46. The method of claim 43, wherein the composition further comprises at least one polycarbonate present in an amount in a range of between about 35 wt. % and about 95 wt. %, based on the weight of the entire composition.

47. The method of claim 46, wherein at least one polycarbonate comprises structural units derived from bisphenol A.

48. The method of claim 43, wherein the composition further comprises an additive selected from the group consisting of mineral flakes, metallic flakes, colorants, dyes, pigments, lubricants, stabilizers, fillers and mixtures thereof.

49. The method of claim 48, wherein at least one additive is an aluminum pigment present in an amount of about 0.3 to about 7 wt. % based on the weight of the entire composition.

50. A method for improving the image texture value of the surface of a thermoplastic article, wherein the article comprises a composition comprising: (i) a rubber modified thermoplastic resin comprising about 35 to about 70 wt. % based on the total weight of the resin of an elastomeric phase comprising structural units derived from either butyl acrylate or butadiene, wherein the elastomeric phase is dispersed in a rigid thermoplastic phase, wherein at least a portion of the rigid thermoplastic phase is grafted to the elastomeric phase, and wherein the rigid thermoplastic phase comprises structural units derived from a monomer mixture comprising styrene and acrylonitrile, or styrene, acrylonitrile and methyl methacrylate, wherein styrene and acrylonitrile are employed in a wt./wt. ratio in a range of between about 1.5:1 and about 4:1, and the wt./wt. ratio of methyl methacrylate to the total of styrene and acrylonitrile is in a range of between about 3:1 and about 1:5; and (ii) a plurality of microsphere beads present in an amount in a range of between about 1 phr and about 14 phr, said beads having a diameter in a range of about 1 to about 1300 microns and having an index of refraction ranging from about 1.4 to about 2.5;
the method comprising the step of adding to the composition at least one image texture enhancing agent selected from the group consisting of poly(acrylic acid), poly(vinyl alcohol), ethylene-acrylic acid copolymers, sodium lauryl sulfate, and mixtures thereof, in an amount in a range of between about 0.1 phr and about 10 phr, wherein the surface of said article exhibits an image texture value of at least 2.5.

51. The method of claim 50, wherein the composition further comprises at least one polycarbonate present in an amount in a range of between about 35 wt. % and about 95 wt. %, based on the weight of the entire composition.

52. The method of claim 51, wherein at least one polycarbonate comprises structural units derived from bisphenol A.

53. The method of claim 50, wherein the composition further comprises an additive selected from the group consisting of mineral flakes, metallic flakes, colorants, dyes, pigments, lubricants, stabilizers, fillers and mixtures thereof.

54. The method of claim 53, wherein at least one additive is an aluminum pigment present in an amount of about 0.3 to about 7 wt. % based on the weight of the entire composition.
